(19) United States
(12) Patent Application Publication
(10) Pub. No.: US 2019/0130811 A1
(43) Pub. Date: May 2, 2019

(54) CORRECTION DATA GENERATION DEVICE, COMPUTER PROGRAM, AND METHOD FOR GENERATING CORRECTION DATA

(71) Applicant: Sakai Display Products Corporation, Osaka (JP)

(72) Inventor: Nobuhiro YONEZAWA, Osaka (JP)

(21) Appl. No.: 16/093,335

(22) PCT Filed: Apr. 13, 2016
(86) PCT No.: PCT/JP2016/061917

§ 371 Date: Oct. 12, 2018

(51) Int. Cl. G09G 3/20

(52) U.S. Cl. CPC G09G 3/2007; G09G 2360/16; G09G 2320/0233

(57) ABSTRACT

A correction-data generation device, a computer program, and a method for generating correction data capable of easily correcting luminance non-uniformity are provided. The correction-data generation device comprises; a display control unit to perform control to display an image having a predetermined gray scale level on a display area; a first receiving unit to receive designation of a portion of the display area as a designated area while the image having the predetermined gray scale level is displayed on the display area; a second receiving unit to receive an adjustment for gray scale level of the image in either the designated area or an area other than the designated area; a calculation unit to calculate a gray scale difference between before and after receiving the adjustment for gray scale level; and a generation unit to generate correction data on the basis of the gray scale difference calculated.

### TECHNICAL FIELD

The present invention relates to a correction-data generation device to generate correction data for correcting luminance non-uniformity in a display area of a display panel, a computer program for realizing the correction-data generation device, and a method for generating correction data.

### BACKGROUND ART

In a display apparatus such as liquid-crystal display apparatus (LCD) and organic electroluminescence display apparatus (OLED), luminance of pixels in an area of a display area can be higher or lower than the luminance of pixels in other area due to various causes related to the manufacturing process, thus, luminance non-uniformity, in which brighter part and darker part appear in the display area, can occur.

Accordingly, an apparatus has been disclosed. In the apparatus, a data generation device for generating correction data takes an image of a display screen with an imaging device while an image corresponding to an image data for testing is displayed on the display screen of the display apparatus, calculate a difference in luminance between dots or between each minute areas on the basis of result of imaging, and sets the gamma value for each of the dots or for each of the minute areas individually according to the calculation result, so as to eliminate luminance non-uniformity in the entire display screen (See Patent Document 1).

### PRIOR ART DOCUMENT

### Patent Document

### Patent Document 1: JP 4942808 B

### SUMMARY OF THE INVENTION

### Problem to be Solved by the Invention

However, in the apparatus according to Patent Document 1, taking an image of the entire display screen with the imaging device is needed. Therefore, as the size of the display apparatus increases, equipment such as the imaging device having expensive lens and camera is needed for precisely calculating the luminance difference, and many sets of expensive equipment are required to be prepared for correcting luminance non-uniformity in many display panels. On the other hand, there are demands for correcting, by a simple means without use of expensive equipment, minor luminance non-uniformity which locally occurs and does not extend to the entire display screen.

The present invention has been made in view of such circumstances, and the object of the present invention is to provide a correction-data generation device which can correct luminance non-uniformity in a simple manner, a computer program for realizing the correction-data generation device, and a method for generating correction data.

### Means to Solve the Problem

A correction-data generation device according to an embodiment of the present invention is a correction-data generation device to generate correction data for correcting luminance non-uniformity in a display area of a display panel, and is characterized in comprising: a display control unit to perform control to display an image having a predetermined gray scale level on the display area; a first receiving unit to receive designation of a portion of the display area as a designated area while the image having the predetermined gray scale level is displayed on the display area; a second receiving unit to receive an adjustment for gray scale level of the image in either the designated area designated with the first receiving unit or an area other than the designated area; a calculation unit to calculate a gray scale difference between before and after receiving the adjustment for gray scale level by the second receiving unit; and a generation unit to generate correction data on the basis of the gray scale difference calculated by the calculation unit.

A computer program according to an embodiment of the present invention is a computer program for causing a computer to generate correction data for correcting luminance non-uniformity in a display area of a display panel, characterized in causing the computer to function as: a display control unit to perform control to display an image having a predetermined gray scale level on the display area; a first receiving unit to receive designation of a portion of the display area as a designated area while the image having the predetermined gray scale level is displayed on the display area; a second receiving unit to receive an adjustment for gray scale level of the image in either the designated area or an area other than the designated area; a calculation unit to calculate a gray scale difference between before and after receiving the adjustment for gray scale level; and a generation unit to generate correction data on the basis of the gray scale difference calculated.

A method for generating correction data according to an embodiment of the present invention is a method for generating correction data to be performed by a correction-data generation device to generate correction data for correcting luminance non-uniformity in a display area of a display panel, characterized in comprising: performing control to display an image having a predetermined gray scale level on the display area; receiving a designation of a portion of the display area as a designated area while the image having the predetermined gray scale level is displayed on the display area; receiving an adjustment for gray scale level of the image in either the designated area or an area other than the designated area; calculating a gray scale difference between before and after receiving the adjustment for gray scale level; and generating correction data on the basis of the gray scale difference calculated.

### Effect of the Invention

According to the present invention, luminance non-uniformity can be easily corrected.

### BRIEF DESCRIPTION OF THE DRAWINGS

FIG. 1 is a block diagram showing an example of a configuration of the correction-data generation device according to the present embodiment.

FIG. 2A is a schematic view showing a first example of correction of luminance non-uniformity by the correction-data generation device according to the present embodiment.

FIG. 2B is a schematic view showing the first example of correction of luminance non-uniformity by the correction-data generation device according to the present embodiment.

FIG. 2C is a schematic view showing the first example of correction of luminance non-uniformity by the correction-data generation device according to the present embodiment.

FIG. 3A is a schematic view showing a first example of generation of correction data by the correction-data generation device according to the present embodiment.

FIG. 3B is a schematic view showing the first example of generation of correction data by the correction-data generation device according to the present embodiment.

FIG. 3C is a schematic view showing the first example of generation of correction data by the correction-data generation device according to the present embodiment.

FIG. 4A is a schematic view showing a second example of correction of luminance non-uniformity by the correction-data generation device according to the present embodiment.

FIG. 4B is a schematic view showing the second example of correction of luminance non-uniformity by the correction-data generation device according to the present embodiment.

FIG. 4C is a schematic view showing the second example of correction of luminance non-uniformity by the correction-data generation device according to the present embodiment.

FIG. 5A is a schematic view showing a second example of generation of correction data by the correction-data generation device according to the present embodiment.

FIG. 5B is a schematic view showing the second example of generation of correction data by the correction-data generation device according to the present embodiment.

FIG. 5C is a schematic view showing the second example of generation of correction data by the correction-data generation device according to the present embodiment.

FIG. 6 is a schematic view showing an example of a method for adjusting gray scale level by the correction-data generation device according to the present embodiment.

FIG. 7 is a flowchart showing an example of a procedure for generation of correction data by the correction-data generation device according to the present embodiment.

### EMBODIMENTS FOR CARRYING OUT THE INVENTION

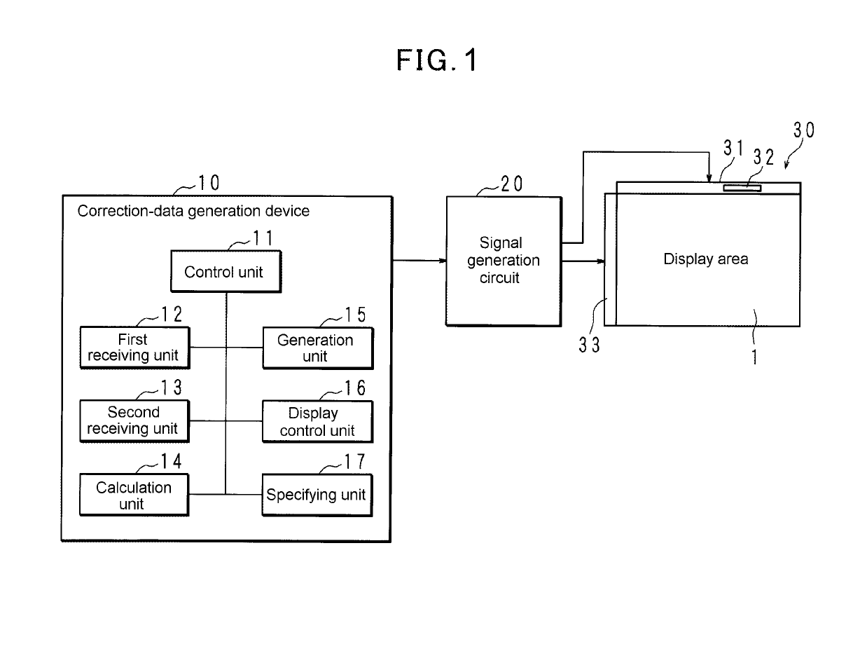

An embodiment of the present invention is described below with reference to the drawings. FIG. 1 is a block diagram showing an example of a configuration of a correction-data generation device 10 according to the present embodiment. The correction-data generation device 10 is connected to a display panel 30 through a signal generation circuit 20 as shown in FIG. 1. The signal generation circuit 20 outputs, for example, image data, control signal for displaying image, and others to the display panel 30 on the basis of commands output by the correction-data generation device 10.

The display panel 30 has a display area (display screen) 1, and is provided with a source substrate 31 on which a source driver is mounted and a gate substrate 33 on which a gate driver is mounted. In addition, a memory (storage unit) 32 is mounted on the source substrate 31. The memory 32 stores correction values for luminance non-uniformity of each pixel composing the display area 1. Specifically, the memory 32 may be an element such as a correction table in which an address is assigned to each pixel composing the display area 1 and the correction values for luminance non-uniformity of each pixel corresponding to each address are stored.

The correction-data generation device 10 includes a control unit 11 which controls the device entirely, a first receiving unit 12, a second receiving unit 13, a calculation unit 14, a generation unit 15, a display control unit 16, and a specifying unit 17.

The display control unit 16 performs control to display an image having a predetermined gray scale level on the display area 1 of the display panel 30. The image having a predetermined gray scale level is, for example, a testing image in which all pixels have the same gray scale level. For example, in the case where a gray scale has 256 levels from “0” (black) to “255” (white), the predetermined gray scale level can be, for example, approximately 200, but is not limited to 200. In the case where the predetermined gray scale level is 200, the image having the predetermined gray scale level is a uniform gray image. By setting the predetermined gray scale level to approximately 200 not being the highest gray scale level, it is possible to display the image such that luminance non-uniformity can be easily found even when the area in which the luminance non-uniformity occurs is brighter than the surrounding areas.

The first receiving unit 12 may be, for example, one of a mouse, a keyboard, a touch panel, and others. The first receiving unit 12 receives designation of a portion of the display area 1 as a designated area while the image having the predetermined gray scale level (e.g., a uniform gray image) is displayed on the display area 1.

When a uniform image in which all the pixels have the same gray scale level is displayed, luminance of the display area 1 is uniform in the case where the display panel 30 has no luminance non-uniformity. However, in the case where the display panel 30 has luminance non-uniformity, an area which is locally bright compared with the surrounding area, or an area which is locally dark compared with the surrounding area occurs in the display area 1. The designated area is, for example, a polygonal area enclosing the local area in which the luminance non-uniformity occurs. The designated area can be designated by manipulating the first receiving unit 12 with, for example, a picture drawing application installed in the correction-data generation device 10.

The second receiving unit 13 receives an adjustment for gray scale level of the image (e.g., a uniform gray image) in either the designated area designated with the first receiving unit 12 or an area other than the designated area. The adjustment for gray scale level is performed so as to eliminate the difference in luminance between the designated area enclosing the area in which luminance non-uniformity occurs and the area other than the designated area. Details of the adjustment for gray scale level of the image are described later. The second receiving unit 13 is, for example, a knob, a button, a switch, a key, or the like for adjusting the gray scale level.

The display control unit 16 displays the image (an uniform image) having the adjusted gray scale level on one of the designated area and the area other than the designated area in the display area 1 when the second receiving unit 13 receives the adjustment for gray scale level. The display control unit 16 may display the image having the adjusted gray scale level on the entire area of the display area 1 excluding the designated area, or on only a portion of an area of the display area 1 excluding the designated area.

The calculation unit 14 calculates a gray scale difference between before and after receiving the adjustment for gray scale level of the image by the second receiving unit 13. For example, when the gray scale level of the image (e.g., a uniform gray image) before receiving the adjustment for gray scale level is 200 and the gray scale level of the image after receiving the adjustment for gray scale level is 195, the gray scale difference is −5 (=195−200).

The generation unit 15 generates correction data on the basis of the gray scale difference calculated by the calculation unit 14. The correction data include a correction value for at least a pixel to be corrected for luminance non-uniformity, and the pixel to be corrected is among pixels each composing the display area 1. For example, in the case where luminance non-uniformity in which an area is darker than the surrounding area occurs and a gray scale level of the image (e.g., a uniform gray image) is adjusted to eliminate the luminance non-uniformity by darkening the luminance of the surrounding area, when a gray scale difference calculated by the calculation unit 14 is, for example, −5, the generation unit 15 generates the correction data so that the correction value for each pixel composing the area other than the designated area is −5 (the initial value of the correction value without the correction being assumed to be, for example, “0”). In this case, the correction value for each pixel composing the designated area is not changed.

Otherwise, in the case where luminance non-uniformity in which an area is darker than the surrounding area occurs and a gray scale level of the image (e.g., a uniform gray image) is adjusted to eliminate the luminance non-uniformity by darkening the luminance of the surrounding area, when a gray scale difference calculated by the calculation unit 14 is, for example, −5, the gray scale level of each pixel composing the designated area may be corrected instead of correcting the gray scale level of each pixel composing the area other than the designated area. In this case, the correction data can be generated such that the correction value for each pixel composing the designated area is +5. In this case, the correction value for each pixel composing the area other than the designated area is not changed.

The configuration described above enables easy correction of luminance non-uniformity without use of an expensive imaging device.

In the present embodiment, the data stored in the memory 32 in the display panel 30 are referred to as “correction values for luminance non-uniformity”, and the data included in the correction data generated by the generation unit 15 are referred to as “correction values”, in order to distinguish both data. In other words, the data before being stored in the memory 32 are the “correction values”, and the data stored in the memory 32 are the “correction value for luminance non-uniformity”.

Next, a method for generating correction data by the correction-data generation device 10 according to the present embodiment is described.

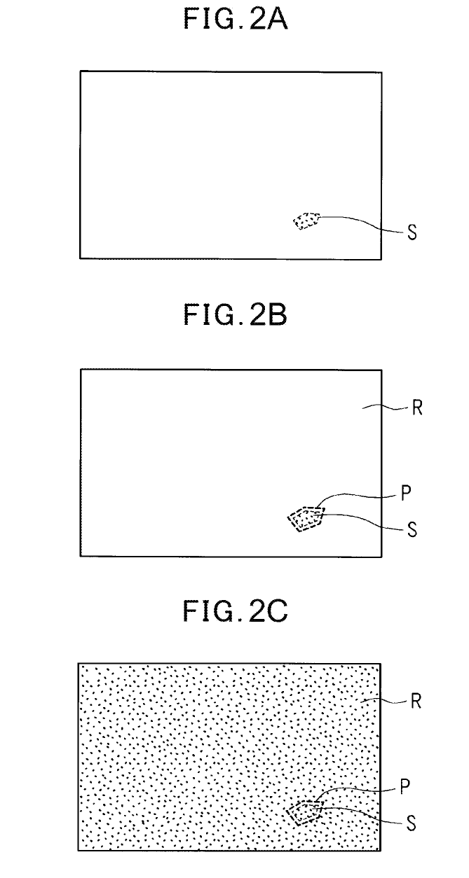

FIG. 2A, FIG. 2B, and FIG. 2C are schematic views showing the first example of correction of luminance non-uniformity by the correction-data generation device 10 according to the present embodiment. FIG. 2 shows an example of adjustment for gray scale level of an image having a predetermined gray scale level when the luminance non-uniformity is corrected. FIG. 2A shows a state in which the image having a predetermined gray scale level (e.g., a uniform gray image) is displayed on the display area 1 of the display panel 30. In FIG. 2A, the area indicated by the reference S is an area in which luminance is lower than the surrounding area and is an area in which luminance non-uniformity occurs.

FIG. 2B shows a state in which a designated area P is designated by manipulating the first receiving unit 12. For example, a user can designate the polygonal designated area P by, for example, drawing a polygonal frame so as to enclose the luminance non-uniformity (the area indicated by the reference S in FIG. 2A) occurring in the display area 1 of the display panel 30. The designated area P is not limited to the polygonal area. The area other than the designated area P in the display area 1 is indicated by the reference R.

Then, the display control unit 16 displays, on the designated area P or the area R other than the designated area P, an image having a gray scale level based on an amount of adjustment received by the second receiving unit 13 when the second receiving unit 13 receives the adjustment for gray scale level of the image.

For example, in the case where the gray scale level of the designated area P is increased by an amount of adjustment Δx (e.g., 1, 2, . . . ) when the adjustment for gray scale level is received to eliminate the difference in the luminance between the designated area P enclosing the area in which the luminance non-uniformity occurs and the area R other than the designated area P, the display control unit 16 increases the gray scale level of the image displayed in the designated area P by the amount of adjustment Δx. Or, in the case where the gray scale level of the area R other than the designated area P is increased by an amount of adjustment Δx (e.g., 1, 2, . . . ), the display control unit 16 increases the gray scale level of the image displayed in the area R other than the designated area P by the amount of adjustment Δx. Further, the operations are similar in the cases where the gray scale level of the image is decreased by an amount of adjustment Δx.

For example, the gray scale level of the image in the area R is adjusted by manipulating the second receiving unit 13 so as to bring the luminance of the area R close to the luminance of the designated area P. In this case, the gray scale level of the image in the area R is gradually decreased in order to slightly darken the area R by lowering the luminance of the area R. For example, the gray scale level can be decreased one level at a time. The gray scale level of the image in the designated area P is not changed. FIG. 2C shows a state in which the luminance of the area R and the luminance of the designated area P are approximately equalized. In the state of FIG. 2C, the adjustment for gray scale level of the image in the area R is completed. In FIG. 2, the difference in the luminance is exaggerated for easy understanding.

According to the above composition, the gray scale level can be adjusted, by easy operations, to eliminate luminance non-uniformity occurring in the display area 1.

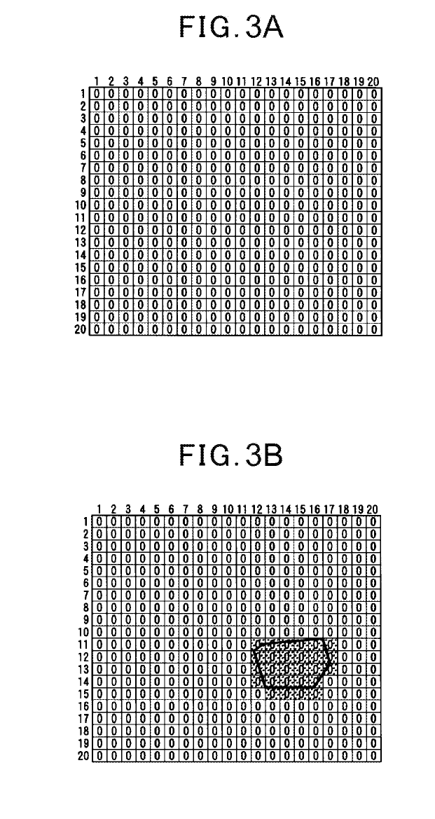

FIG. 3A, FIG. 3B, and FIG. 3C are schematic views showing a first example of generation of correction data by the correction-data generation device 10 according to the present embodiment. FIG. 3 shows an example of a process for generating correction data when luminance non-uniformity is corrected. In FIG. 3, the pixels each composing the display area 1 are represented by a pixel block consisting of 20×20 pixels for simple illustration. In this case, the correction data include 400 (20×20) correction values. The states of FIG. 3A, FIG. 3B, and FIG. 3C respectively correspond to the states of FIG. 2A, FIG. 2B, and FIG. 2C.

FIG. 3A shows the correction values for pixels each composing the display area 1 before the luminance non-uniformity is corrected while the image having a predetermined gray scale level (e.g., a uniform gray image) is displayed on the display area 1 of the display panel 30 as shown in FIG. 2A. For convenience, “0” is assigned to every pixel.

FIG. 3B shows a state in which the designated area P is designated as shown in FIG. 2B and the pixels composing the designated area P are indicated by enclosing the pixels with a frame. FIG. 3B displays the pixels composing the designated area P and the pixels composing the area R other than the designated area P in such a manner that the pixels composing the designated area P and the area R respectively are distinguished from each other.

FIG. 3C shows a state in which the adjustment for gray scale level of the image in the area R is completed as shown in FIG. 2C. As shown in FIG. 3C, in this example, the luminance of the area R and the luminance of the designated area P are approximately equalized by decreasing the gray scale level of the image in the area R by 5. FIG. 3C shows the correction values for the pixels each composing the display area 1 after the luminance non-uniformity is corrected, and shows correction data which are finally generated.

In the example of FIG. 2 and FIG. 3, the calculation unit 14 calculates “−5” as the gray scale difference between before and after receiving the adjustment for gray scale level of the image by the second receiving unit 13.

The control unit 10 has a function of an output unit, and outputs the correction data generated by the generation unit 15 to the display panel 30. Thus, the correction data generated by the generation unit 15 can be written into the display panel 30.

More specifically, the control unit 10 outputs the correction data to the display panel 30 in order to update the correction values for luminance non-uniformity stored in the memory 32 in the display panel 30 with the correction values included in the correction data generated by the generation unit 15.

For example, the correction values for luminance non-uniformity stored in the memory 32 in the display panel 30 can be updated as follows. The specifying unit 17 shown in FIG. 1 specifies addresses, in the memory 32, corresponding to the designated area P or the area R other than the designated area P on the basis of the designated area P designated with the first receiving unit 12. For example, in the case where the gray scale level of the image in the area R other than the designated area P is adjusted as shown in FIG. 2 and FIG. 3, the specifying unit 17 specifies addresses, in the memory 32, corresponding to the area R. In other words, the specifying unit 17 specifies the addresses, in the memory 32, corresponding to the respective pixels of the area R among the 20×20 pixels exemplified in FIG. 3.

The control unit 11 updates the correction values for luminance non-uniformity stored in the addresses specified by the specifying unit 17, with the correction values included in the correction data generated by the generation unit 15.

As described above, when the gray scale level of the image in the area R other than the designated area P is adjusted to eliminate luminance non-uniformity, it is possible to update the correction values for luminance non-uniformity stored in the addresses, in the memory 32, corresponding to the area R. In addition, the luminance non-uniformity can be easily corrected without using an expensive imaging device.

In the example of FIG. 2 and FIG. 3, the luminance of the area R is lowered by decreasing the gray scale level of the image in the area R. However, the present embodiment is not limited to such an example. For example, the gray scale level of the image in the designated area P may be increased to raise the luminance of the designated area P. In this case, since the gray scale level of the image in the designated area P is adjusted, the specifying unit 17 specifies addresses, in the memory 32, corresponding to the designated area P.

For example, when a gray scale difference between before and after receiving, by the second receiving unit 13, the adjustment for gray scale level of the image is assumed to be “5”, “0” is stored in space where “−5” has been stored in FIG. 3C, and “5” is stored in space where “0” has been stored in FIG. 3C. Thus, when the gray scale level of the image in the designated area P is adjusted to eliminate the luminance non-uniformity, the correction values for luminance non-uniformity stored in the addresses, in the memory 32, corresponding to the designated area P can be updated.

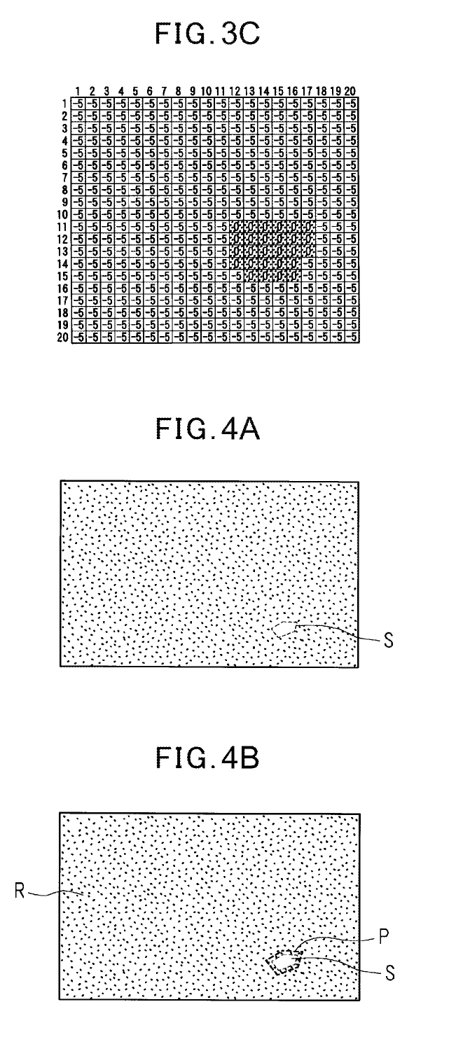

FIG. 4A, FIG. 4B, and FIG. 4C are schematic views showing a second example of correction of luminance non-uniformity by the correction-data generation device 10 according to the present embodiment. FIG. 4 shows an example of adjustment for gray scale level of an image having a predetermined gray scale level when the luminance non-uniformity is corrected. In FIG. 4A, the area indicated by the reference S is an area in which luminance is brighter than the surrounding area, and indicates occurrence of the luminance non-uniformity.

FIG. 4B shows a state in which a designated area P is designated by manipulating the first receiving unit 12 similarly to FIG. 2B. For example, a user can designate the polygonal designated area P by, for example, drawing a polygonal frame so as to enclose the luminance non-uniformity (the area indicated by the reference S in FIG. 4A) occurring in the display area 1 of the display panel 30. The area other than the designated area P in the display area 1 is indicated by the reference R.

Then, the gray scale level of the image in the area R is adjusted by manipulating the second receiving unit 13 so as to bring the luminance of the area R close to the luminance of the designated area P. In this case, the gray scale level of the image in the area R is gradually increased in order to slightly brighten the area R by raising the luminance of the area R. For example, the gray scale level can be raised one level at a time. The gray scale level of the image in the designated area P is not changed. FIG. 4C shows a state in which the luminance of the area R and the luminance of the designated area P are approximately equalized. In the state of FIG. 4C, the adjustment for gray scale level of the image in the area R is completed.

In the case of FIG. 4, similar to the case of FIG. 2, the gray scale level can be adjusted, by easy operations, to eliminate luminance non-uniformity occurring in the display area 1.

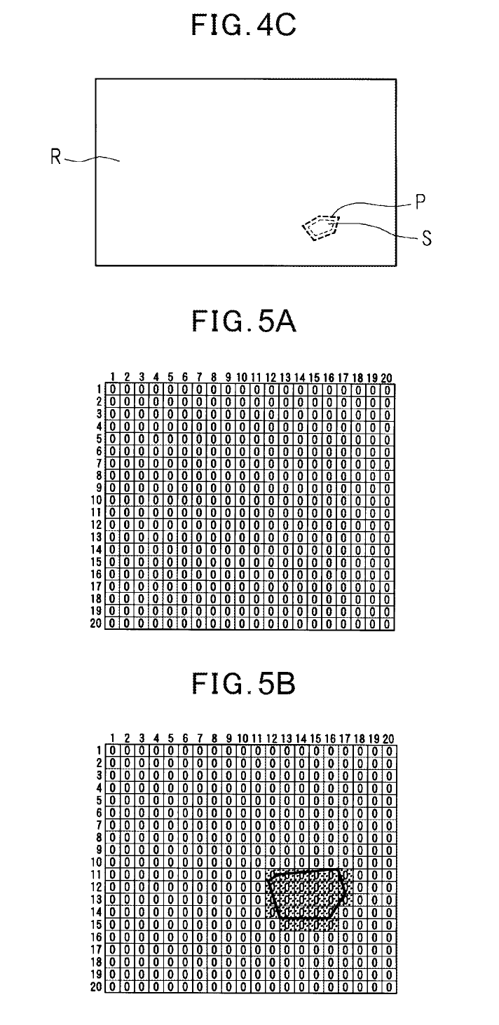

FIG. 5A, FIG. 5B, and FIG. 5C are schematic views showing a second example of generation of correction data by the correction-data generation device 10 according to the present embodiment. FIG. 5 shows an example of a process for generating correction data when luminance non-uniformity is corrected in a similar manner to the case of FIG. 3. In FIG. 5, the pixels each composing the display area 1 are represented by a pixel block consisting of 20×20 pixels for simple illustration. In this case, the correction data include 400 (20×20) correction values. The states of FIG. 5A, FIG. 5B, and FIG. 5C respectively correspond to the states of FIG. 4A, FIG. 4B, and FIG. 4C.

FIG. 5A shows the correction values for pixels each composing the display area 1 before the luminance non-uniformity is corrected while the image having a predetermined gray scale level (e.g., a uniform gray image) is displayed on the display area 1 of the display panel 30 as shown in FIG. 4A. For convenience, “0” is assigned to every pixel.

FIG. 5B shows a state in which the designated area P is designated as shown in FIG. 4B and the pixels composing the designated area P are indicated by enclosing the pixels with a frame. FIG. 5B displays the pixels composing the designated area P and the pixels composing the area R other than the designated area P in such a manner that the pixels composing the designated area P and the area R respectively are distinguished from each other.

FIG. 5C shows a state in which the adjustment for gray scale level of the image in the area R is completed as shown in FIG. 4C. As shown in FIG. 5C, in this example, the luminance of the area R and the luminance of the designated area P are approximately equalized by raising the gray scale level of the image in the area R by 5. FIG. 5C shows the correction values for the pixels each composing the display area 1 after the luminance non-uniformity is corrected, and shows correction data which are finally generated.

In the example of FIG. 4 and FIG. 5, the calculation unit 14 calculates “5” as the gray scale difference between before and after receiving the adjustment for gray scale level of the image by the second receiving unit 13.

In the example of FIG. 4 and FIG. 5, similar to the example of FIG. 2 and FIG. 3, the control unit 10 outputs the correction data generated by the generation unit 15 to the display panel 30. Thus, the correction data generated by the generation unit 15 can be written into the display panel 30.

As described above, when the gray scale level of the image in the area R other than the designated area P is adjusted to eliminate luminance non-uniformity, it is possible to update the correction values for luminance non-uniformity stored in the addresses, in the memory 32, corresponding to the area R. In addition, the luminance non-uniformity can be easily corrected without using an expensive imaging device.

In the example of FIG. 4 and FIG. 5, the luminance of the area R is raised by raising the gray scale level of the image in the area R. However, the present embodiment is not limited to such an example. For example, the gray scale level of the image in the designated area P may be decreased to lower the luminance of the designated area P. In this case, since the gray scale level of the image in the designated area P is adjusted, the specifying unit 17 specifies addresses, in the memory 32, corresponding to the designated area P.

For example, when a gray scale difference between before and after receiving, by the second receiving unit 13, the adjustment for gray scale level of the image is assumed to be “5”, “0” is stored in space where “5” has been stored in FIG. 5C, and “−5” is stored in space where “0” has been stored in FIG. 5C. Thus, when the gray scale level of the image in the designated area P is adjusted to eliminate the luminance non-uniformity, the correction values for luminance non-uniformity stored in the addresses, in the memory 32, corresponding to the designated area P can be updated.

In the above examples, the second receiving unit 13 is, for example, a knob, a button, a switch, a key, or the like for adjusting the gray scale level, and the gray scale level is increased or decreased by one level at a time. However, the present embodiment is not limited to such examples. A pattern image for adjusting the gray scale level can be displayed.

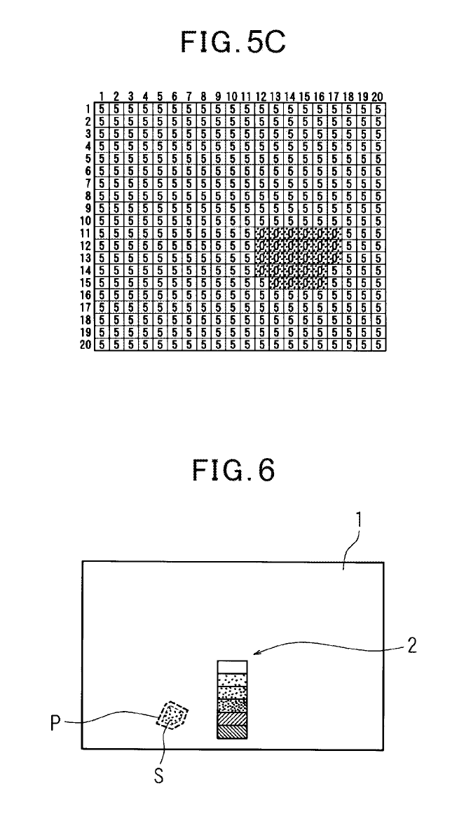

FIG. 6 is a schematic view showing an example of a method for adjusting gray scale level by the correction-data generation device 10 according to the present embodiment. According to the adjustment method shown in FIG. 6, when the second receiving unit 13 receives the adjustment for gray scale level of the image, the display control unit 16 displays a plurality of pattern images 2 having different gray scale levels on the display area 1. In this case, the second receiving unit 13 receives a gray scale level of one pattern image 2, as a gray scale level after the adjustment, which is selected from the plurality of pattern images 2.

For example, when the adjustment for gray scale level is received to eliminate the gray scale difference between the designated area P enclosing the area in which luminance non-uniformity occurs and the area R other than the designated area P, the display control unit 16 as shown in FIG. 6 displays the plurality of pattern images 2 having different gray scale levels on display area 1 (on the area R in the example of FIG. 6). For example, a necessary number of gray scale levels falling within a range of gray scale level can be used for the gray scale levels of the plurality of pattern images 2, the range of gray scale level ranging from a gray scale level equal to or more than a gray scale level smaller than the predetermined gray scale level to a gray scale level equal to or less than a gray scale level greater than the predetermined gray scale level.

A user compares the luminance of each of the displayed pattern images 2 and the luminance of the designated area P and selects a pattern image 2 having the closest luminance, therefore, a pattern image 2 having approximately the same luminance as the luminance of the designated area P is selected. Then, the second receiving unit 13 receives the gray scale level of the selected pattern image 2 as the gray scale level after the adjustment. Therefore, the difference between the gray scale level of the selected pattern image 2 and the predetermined gray scale level is the gray scale difference between before and after receiving the adjustment for gray scale level.

According to the composition described above, it is unnecessary to repeatedly change the gray scale level by one level. Therefore, it is possible to perform the adjustment for gray scale level quickly and easily to eliminate the luminance non-uniformity occurring in the display area 1.

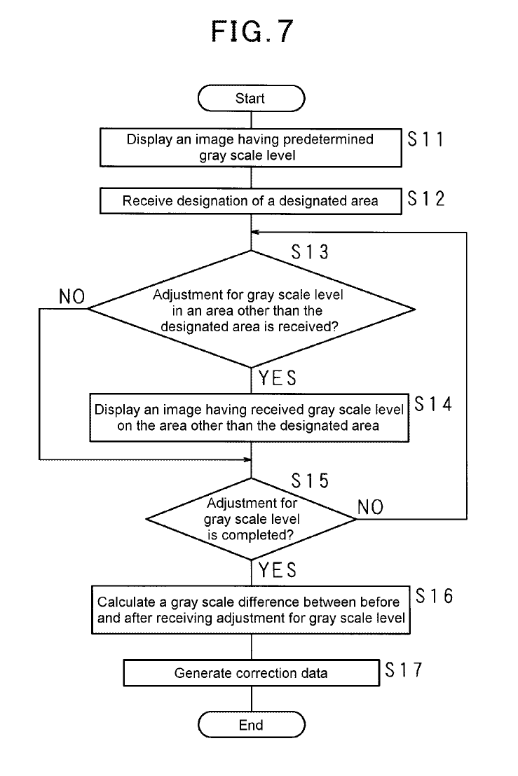

Next, the operation of the correction-data generation device 10 according to the present embodiment is described. FIG. 7 is a flowchart showing an example of a procedure for generation of correction data by the correction-data generation device 10 according to the present embodiment. In the following description, the control unit 11 is regarded as a subject to perform each operation, for convenience. The control unit 11 displays an image having a predetermined gray scale level (e.g., a uniform gray image) on the display area 1 in the display panel 30 (S11).

The control unit 11 receives designation of a portion of the display area as a designated area P (S12). In this case, a user can designate the designated area P by enclosing an area S in which luminance non-uniformity, by using a drawing application. The control unit 11 determines whether or not adjustment for gray scale level of the area R other than the designated area P is received (S13).

When the adjustment for gray scale level is received (YES in S13), the control unit 11 displays an image having the received gray scale level in the area R other than the designated area P (S14). Thereby, the user can confirm whether or not the luminance of the image after the adjustment for gray scale level is approximately equalized to the luminance of the area S in which the luminance non-uniformity. The control unit 11 determines whether or not the adjustment for gray scale level is completed (S15). It is possible to determine, by the user's manipulation, whether or not the adjustment for gray scale level is completed. In the case where the adjustment for gray scale level is not received (NO in S13), the control unit 11 performs the operation in step S15 without performing the operation in step S14.

In the case where the adjustment for gray scale level is not completed (NO in S15), the control unit 11 continues the operation from step S13. In the case where the adjustment for gray scale level is completed (YES in S15), the control unit 11 calculates a gray scale difference between before and after receiving the adjustment for gray scale level (S16), generates correction data on the basis of the calculated gray scale difference (S17), and completes the operation.

The control unit 11 outputs the generated correction data to the display panel 30 in order to store the correction data in the memory 32 in the display panel 30 although it is not shown in FIG. 7. Thus, the correction data can be written into the display panel 30. More specifically, the control unit 11 updates the correction values for luminance non-uniformity stored in the addresses, in the memory 32, which are specified by the specifying unit 17 with the correction values in the generated correction data.

In the example of FIG. 7, the operation in which the adjustment for gray scale level in the area R other than the designated area P is received in step S13 is exemplified. However, the present embodiment is not limited to such an example, and an operation in which adjustment of the gray scale level in the designated area P is received can be performed. In this case, the image having the received gray scale level is displayed on the designated area P in step S14.

In the case where more than one area in which luminance non-uniformity occurs exists in the display area 1, it is possible to perform the operations in FIG. 7 for each area in which the luminance non-uniformity occurs.

The correction-data generation device 10 according to the present embodiment can be realized by using a general-purpose computer having, for example, a CPU (processor), an RAM, and the like. Specifically, the correction-data generation device 10 can be realized on the computer by loading, in the RAM provided in the computer, a computer program in which procedures of the respective operations as indicated in FIG. 7 are defined, and executing the computer program by the CPU (processor).

In the embodiment described above, the signal generation circuit 20 and the correction-data generation device 10 are described as individual devices. However, the present embodiment is not limited to the above embodiment, and the signal generation circuit 20 may be incorporated in the correction-data generation device 10.

In addition, the configurations in the respective examples described above can be combined to each other, and new technical features can be formed by the combinations.

The correction-data generation device according to an embodiment of the present invention is a correction-data generation device to generate correction data for correcting luminance non-uniformity in a display area of a display panel, and is characterized in comprising: a display control unit to perform control to display an image having a predetermined gray scale level on the display area; a first receiving unit to receive designation of a portion of the display area as a designated area while the image having the predetermined gray scale level is displayed on the display area; a second receiving unit to receive an adjustment for gray scale level of the image in either the designated area designated with the first receiving unit or an area other than the designated area; a calculation unit to calculate a gray scale difference between before and after receiving the adjustment for gray scale level by the second receiving unit; and a generation unit to generate correction data on the basis of the gray scale difference calculated by the calculation unit.

The computer program according to an embodiment of the present invention is a computer program for causing a computer to generate correction data for correcting luminance non-uniformity in a display area of a display panel, characterized in causing the computer to function as: a display control unit to perform control to display an image having a predetermined gray scale level on the display area; a first receiving unit to receive designation of a portion of the display area as a designated area while the image having the predetermined gray scale level is displayed on the display area; a second receiving unit to receive an adjustment for gray scale level of the image in either the designated area or an area other than the designated area; a calculation unit to calculate a gray scale difference between before and after receiving the adjustment for gray scale level; and a generation unit to generate correction data on the basis of the gray scale difference calculated.

The method for generating correction data according to an embodiment of the present invention is a method for generating correction data to be performed by a correction-data generation device to generate correction data for correcting luminance non-uniformity in a display area of a display panel, characterized in comprising: performing control to display an image having a predetermined gray scale level on the display area; receiving a designation of a portion of the display area as a designated area while the image having the predetermined gray scale level is displayed on the display area; receiving an adjustment for gray scale level of the image in either the designated area or an area other than the designated area; calculating a gray scale difference between before and after receiving the adjustment for gray scale level; and generating correction data on the basis of the gray scale difference calculated.

The display control unit performs control to display an image having a predetermined gray scale level on the display area of the display panel. The image having a predetermined gray scale level is, for example, a testing image in which all pixels have the same gray scale level. For example, in the case where a gray scale has 256 levels from “0” (black) to “255” (white), the predetermined gray scale level can be, for example, approximately 200.

The first receiving unit receives designation of a portion of the display area as a designated area while the image having the predetermined gray scale level is displayed on the display area. When an image in which all the pixels have the same gray scale level is displayed, the luminance of the display area is uniform in the case where the display panel has no luminance non-uniformity. However, in the case where the display panel has luminance non-uniformity, an area which is locally bright compared with the surrounding area or an area which is locally dark compared with the surrounding area occurs in the display area. The designated area is, for example, a polygonal area enclosing the local area in which the luminance non-uniformity occurs. The designated area can be designated, for example, by using a drawing application and manipulating a mouse, a keyboard, a touch panel, or the like.

The second receiving unit receives an adjustment for gray scale level of the image in either the designated area designated with the first receiving unit or an area other than the designated area. The adjustment for gray scale level is performed so as to eliminate the difference in luminance between the designated area enclosing the area in which luminance non-uniformity occurs and the area other than the designated area. For example, in the case where luminance non-uniformity in which an area is darker than the surrounding area occurs, the gray scale level of the image may be adjusted so as to darken the surrounding areas or brighten the area with the luminance non-uniformity for eliminating the luminance non-uniformity. In addition, in the case where luminance non-uniformity in which an area is brighter than the surrounding area occurs, the gray scale level of the image may be adjusted so as to brighten the surrounding areas or darken the area with the luminance non-uniformity for eliminating the luminance non-uniformity.

The calculation unit calculates a gray scale difference between before and after receiving the adjustment by the second receiving unit. For example, when the gray scale level of the image before receiving the adjustment for gray scale level is 200 and the gray scale level of the image after receiving the adjustment for gray scale level is 195, the gray scale difference is −5 (=195−200).

The generation unit generates correction data on the basis of the gray scale difference calculated by the calculation unit. For example, in the case where luminance non-uniformity in which an area is darker than the surrounding area occurs and a gray scale level of the image is adjusted to eliminate the luminance non-uniformity by darkening the luminance of the surrounding area, when a gray scale difference calculated by the calculation unit is, for example, −5, the generation unit generates the correction data so that the correction value for the area other than the designated area is “−5” (the initial value of the correction value without the correction being assumed to be, for example, “0”). In this case, the correction value for the designated area is not changed. The configuration described above enables easy correction of luminance non-uniformity without use of an expensive imaging device.

The correction-data generation device according to an embodiment of the present invention is characterized in that the display control unit displays, on the designated area or the area other than the designated area, an image having a gray scale level based on an amount of adjustment received by the second receiving unit, when the second receiving unit receives the adjustment for gray scale level of the image.

When the second receiving unit receives the adjustment of the gray scale level of the image, the display control unit displays, in the designated area or the area other than the designated area, an image having a gray scale level based on an adjustment amount which the second receiving unit receives.

For example, in the case where the gray scale level of the designated area is increased by an amount of adjustment Δx (e.g., 1, 2, . . . ) when the adjustment for gray scale level is received to eliminate the difference in the luminance between the designated area enclosing the area in which the luminance non-uniformity occurs and the area other than the designated area, the display control unit increases the gray scale level of the image displayed in the designated area by the amount of adjustment Δx. Or, in the case where the gray scale level of the area other than the designated area is increased by an amount of adjustment Δx (e.g., 1, 2, . . . ), the display control unit increases the gray scale level of the image displayed in the area other than the designated area by the amount of adjustment Δx.

According to the above composition, the gray scale level can be adjusted, by easy operations, to eliminate luminance non-uniformity occurring in the display area.

The correction-data generation device according to an embodiment of the present invention is characterized in that the display control unit displays a plurality of pattern images having different gray scale levels on the display area when the second receiving unit receives the adjustment for gray scale level of the image, and the second receiving unit receives a gray scale level of one pattern image as a gray scale level after adjustment, wherein the one pattern image is selected from the plurality of pattern images.

When the second receiving unit receives the adjustment for gray scale level of the image, the display control unit displays the plurality of pattern images having different gray scale levels on the display area. The second receiving unit receives a gray scale level of one pattern image, as a gray scale level after the adjustment, which is selected from the plurality of pattern images.

For example, when the adjustment for gray scale level is received to eliminate the gray scale difference between the designated area enclosing the area in which luminance non-uniformity occurs and the area other than the designated area, the display control unit displays the plurality of pattern images having different gray scale levels on the display area. For example, a necessary number of gray scale levels falling within a range of gray scale level can be used for the gray scale levels of the plurality of pattern images, the range of gray scale level ranging from a gray scale level equal to or more than a gray scale level smaller than the predetermined gray scale level to a gray scale level equal to or less than a gray scale level greater than the predetermined gray scale level. When the user selects a pattern image having approximately the same luminance as the luminance of the designated area, the second receiving unit receives the gray scale level of the selected pattern image as the gray scale level after the adjustment. Therefore, the difference between the gray scale level of the selected pattern image and the predetermined gray scale level is the gray scale difference between before and after receiving the adjustment for gray scale level.

According to the composition described above, it is possible to perform the adjustment for gray scale level quickly and easily to eliminate the luminance non-uniformity occurring in the display area.

The correction-data generation device according to an embodiment of the present invention is characterized in further comprising an output unit to output the correction data generated by the generation unit to the display panel.

The output unit outputs the correction data generated by the generation unit to the display panel. Thus, the correction data can be written into the display panel.

In the correction-data generation device according to an embodiment of the present invention, the correction data comprise a correction value for at least a pixel to be corrected for luminance non-uniformity, wherein the pixel is among pixels each composing the display area; and the output unit outputs the correction data to the display panel to update, with the correction value, stored correction values for luminance non-uniformity of the pixels each composing the display area, the stored correction values for luminance non-uniformity being stored in a storage unit provided in the display panel.

The correction data include correction values for at least a pixel to be corrected for luminance non-uniformity, and the pixel to be corrected is among pixels each composing the display area. The display panel includes a storage unit. The storage unit stores correction values for luminance non-uniformity of each pixel composing the display area. The output unit outputs the correction data to the display panel to update the correction values for luminance non-uniformity stored in the storage unit, with the correction values included in the correction data.

Thereby, for example, when the gray scale level of the image is adjusted in the area other than the designated area so as to eliminate luminance non-uniformity, the correction values for luminance non-uniformity for each pixel composing the area can be updated. In addition, when the gray scale level of the image is adjusted in the designated area so as to eliminate luminance non-uniformity, the correction values for luminance non-uniformity for each pixel composing the designated area can be updated.

### EXPLANATION OF SYMBOLS

1 Display area
10 Correction-data generation device
11 Control unit
12 First receiving unit
13 Second receiving unit
14 Calculation unit
15 Generation unit
16 Display control unit
17 Specifying unit
30 Display panel
32 Memory

1. A correction-data generation device to generate correction data for correcting luminance non-uniformity in a display area of a display panel, comprising:
a display control unit to perform control to display an image having a predetermined gray scale level on the display area;
a first receiving unit to receive designation of a portion of the display area as a designated area while the image having the predetermined gray scale level is displayed on the display area;
a second receiving unit to receive an adjustment for gray scale level of the image in either the designated area designated with the first receiving unit or an area other than the designated area;
a calculation unit to calculate a gray scale difference between before and after receiving the adjustment for gray scale level by the second receiving unit; and
a generation unit to generate correction data on the basis of the gray scale difference calculated by the calculation unit.

2. The correction-data generation device according to claim 1, wherein the display control unit displays, on the designated area or the area other than the designated area, an image having a gray scale level based on an amount of adjustment received by the second receiving unit, when the second receiving unit receives the adjustment for gray scale level of the image.

3. The correction-data generation device according to claim 1, wherein
the display control unit displays a plurality of pattern images having different gray scale levels on the display area when the second receiving unit receives the adjustment for gray scale level of the image, and
the second receiving unit receives a gray scale level of one pattern image as a gray scale level after the adjustment, wherein the one pattern image is selected from the plurality of pattern images.

4. The correction-data generation device according to claim 1, further comprising an output unit to output correction data generated by the generation unit to the display panel.

5. The correction-data generation device according to claim 4, wherein
the correction data comprise a correction value for at least a pixel to be corrected for luminance non-uniformity, wherein the pixel is among pixels each composing the display area; and
the output unit outputs the correction data to the display panel to update, with the correction value, stored correction values for luminance non-uniformity of the pixels each composing the display area, the stored correction values for luminance non-uniformity being-stored in a storage unit provided in the display panel.

6. (canceled)

7. A method for generating correction data to be performed by a correction-data generation device to generate correction data for correcting luminance non-uniformity in a display area of a display panel, comprising:
performing control to display an image having a predetermined gray scale level on the display area;
receiving a designation of a portion of the display area as a designated area while the image having the predetermined gray scale level is displayed on the display area;
receiving an adjustment for gray scale level of the image in either the designated area or an area other than the designated area;
calculating a gray scale difference between before and after receiving the adjustment for gray scale level; and
generating correction data on the basis of the gray scale difference calculated.
